(19) United States
(12) Patent Application Publication
(10) Pub. No.: US 2025/0386230 A1
(43) Pub. Date: Dec. 18, 2025

(54) MEASUREMENT CONFIGURATION METHOD AND APPARATUS, DEVICE, AND STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/879,144

(22) PCT Filed: Jun. 27, 2022
(86) PCT No.: PCT/CN2022/101695

§ 371 Date: Dec. 26, 2024

(51) Int. Cl. H04W 24/10

(52) U.S. Cl. CPC H04W 24/10

(57) ABSTRACT

The present disclosure provides a measurement configuration method and apparatus, a device, and a storage medium, and relates to the field of communication technology. The method includes: determining, in response to that an inter-frequency measurement is to be performed on a to-be-measured inter-frequency reference signal, whether the to-be-measured inter-frequency reference signal is to be measured based on a measurement gap.

### CROSS-REFERENCE TO RELATED APPLICATION

The present application is a U.S. National Stage of International Application No. PCT/CN2022/101695, filed on Jun. 27, 2022, the contents of which are incorporated herein by reference in their entirety.

### TECHNICAL FIELD

The present disclosure relates to the field of communication technology, and in particular, to measurement configuration methods, apparatuses, devices and storage media.

### BACKGROUND

In communication systems, terminal devices typically perform measurements on neighboring cell reference signals. These measurements include both intra-frequency measurement and inter-frequency measurement.

In related technologies, when performing an inter-frequency measurement on an inter-frequency reference signal of a neighboring cell, the inter-frequency measurement is usually based on a measurement gap. During the measurement gap, a terminal device interrupts communication with a current serving cell, does not transmit or receive data from the current serving cell, and only performs the inter-frequency measurement on the inter frequency reference signal of the neighboring cell.

However, some inter-frequency measurements may not require the measurement gap. For example, when a resource location of a to-be-measured inter-frequency reference signal is included in a downlink active bandwidth of the current serving cell of the terminal device, it is unnecessary to perform the inter-frequency measurement on the inter-frequency reference signal based on the measurement gap. Based on this, if the method in related technologies is adopted, i.e., performing measurements based on the measurement gap for all inter-frequency measurements, there will be a situation where “an inter-frequency measurement that does not require the use of measurement gap is also performed based on the measurement gap”, which will cause unnecessarily interrupt communication between the terminal device and the current serving cell and reduce the throughput of the terminal device.

### SUMMARY

The present disclosure provides measurement configuration methods, apparatuses, devices, and storage media to solve the technical problem that the method in the related art is easy to reduce the throughput of terminal device.

In a first aspect, an embodiment of the present disclosure provides a measurement configuration method, which is performed by a terminal device and includes: determining, in response to that an inter-frequency measurement is to be performed on a to-be-measured inter-frequency reference signal, whether the to-be-measured inter-frequency reference signal is to be measured based on a measurement gap.

In the present disclosure, a measurement configuration method is provided, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

In some examples, the method further includes: reporting capability information to a network device, where the capability information indicates, when a resource location of the to-be-measured inter-frequency reference signal is comprised within a downlink active bandwidth part (BWP) of a current serving cell of the terminal device, whether the terminal device supports an inter-frequency measurement without the measurement gap.

In some examples, the determining whether the to-be-measured inter-frequency reference signal is to be measured based on a measurement gap includes: receiving indication signaling sent by the network device, where the indication signaling indicates whether a measurement gap is necessary for the terminal device to perform the inter-frequency measurement on the to-be-measured inter-frequency reference signal; and measuring the inter-frequency reference signal based on the indication signaling.

In some examples, the measuring the inter-frequency reference signal based on the indication signaling includes: determining, in response to the indication signaling indicating that a measurement gap is not necessary for the terminal device to perform the inter-frequency measurement on the to-be-measured inter-frequency reference signal, which includes at least one of: in a case that the terminal device is in a time division duplexing (TDD) bandwidth, the terminal device not performing an uplink transmission during a measurement on the to-be-measured inter-frequency reference signal; in a case that a sub-carrier spacing (SCS) of the to-be-measured inter-frequency reference signal is different from a SCS of data and/or signal in the current serving cell, the terminal device not performing an uplink transmission or a downlink reception during the measurement on the to-be-measured inter-frequency reference signal; or in a case that the terminal device is in a frequency range 2 (FR2) system, the terminal device not performing uplink transmission or downlink reception during the measurement on the to-be-measured inter-frequency reference signal; and measuring the to-be-measured inter-frequency reference signal based on the measurement scheduling requirement.

In some examples, the terminal device not performing an uplink transmission during the measurement on the to-be-measured inter-frequency reference signal includes: measuring, by the terminal device and at the resource location of the to-be-measured inter-frequency reference signal and at N resource locations before and after the resource location of the to-be-measured inter-frequency reference signal, the inter-frequency reference signal but not performing the uplink transmission; where the terminal device not performing a downlink reception during the measurement on the to-be-measured inter-frequency reference signal includes: measuring, by the terminal device and at the resource location of the to-be-measured inter-frequency reference signal and at N resource locations before and after the resource location of the to-be-measured inter-frequency reference signal, the inter-frequency reference signal but not performing the downlink reception.

In some examples, the determining a measurement scheduling requirement includes: determining the measurement scheduling requirement based on a protocol agreement.

In some examples, the uplink transmission includes at least one of: sending a PUCCH; sending a PUSCH; or sending an SRS.

In some examples, the downlink reception includes at least one of: receiving a PDCCH; receiving a PDSCH; receiving a TRS; or receiving a CSI-RS for CQI.

In some examples, the measuring the inter-frequency reference signal based on the indication signaling includes: performing, in response to the indication signaling indicating that a measurement gap is necessary for the terminal device to perform the inter-frequency measurement on the to-be-measured inter-frequency reference signal, the inter-frequency measurement on the to-be-measured inter-frequency reference signal based on the measurement gap.

In some examples, the determining whether the to-be-measured inter-frequency reference signal is to be measured based on a measurement gap includes: performing in a case that the terminal device does not report the capability information to the network device, the inter-frequency measurement on the to-be-measured inter-frequency reference signal based on the measurement gap.

In some examples, the to-be-measured inter-frequency reference signal includes at least one of: an SSB; a CSI-RS; or a PRS.

In a second aspect, an embodiment of the present disclosure provides a measurement configuration method, which is performed by a network device and includes: receiving capability information reported by a terminal device, where the capability information indicates, when a resource location of a to-be-measured inter-frequency reference signal is included within a downlink active bandwidth part (BWP) of a current serving cell of the terminal device, whether the terminal device supports an inter-frequency measurement without a measurement gap.

In some examples, the method further includes: sending indication signaling to the terminal device, where the indication signaling indicates whether a measurement gap is necessary for the terminal device to perform the inter-frequency measurement on the to-be-measured inter-frequency reference signal.

In some examples, sending the indication signaling to the terminal device based on the capability information includes: sending, in response to the capability information indicating that the terminal device supports the inter-frequency measurement without the measurement gap when the resource location of the to-be-measured inter-frequency reference signal is included within the downlink active BWP of the current serving cell of the terminal device, the indication signaling to the terminal device for indicating that a measurement gap is not necessary for the terminal device to perform the inter-frequency measurement on the to-be-measured inter-frequency reference signal.

In some examples, sending the indication signaling to the terminal device based on the capability information includes: sending, in response to the capability information indicating that the terminal device supports the inter-frequency measurement without the measurement gap when the resource location of the to-be-measured inter-frequency reference signal is included within the downlink active BWP of the current serving cell of the terminal device, the indication signaling to the terminal device for indicating that a measurement gap is necessary for the terminal device to perform the inter-frequency measurement on the to-be-measured inter-frequency reference signal.

In some examples, sending the indication signaling to the terminal device based on the capability information includes: sending, in response to the capability information indicating that the terminal device does not support the inter-frequency measurement without the measurement gap when the resource location of the to-be-measured inter-frequency reference signal is included within the downlink active BWP of the current serving cell of the terminal device, the indication signaling to the terminal device for indicating that a measurement gap is necessary for the terminal device to perform the inter-frequency measurement on the to-be-measured inter-frequency reference signal.

In some examples, the method further includes at least one of: determining a measurement scheduling requirement, where the measurement scheduling requirement includes at least one of: in a case that the terminal device is in a time division duplexing (TDD) bandwidth, the network device not monitoring and receiving an uplink transmission from the terminal device during a measurement on the to-be-measured inter-frequency reference signal by the terminal device; in a case that a sub-carrier spacing (SCS) of the to-be-measured inter-frequency reference signal is different from a SCS of data and/or signal in the current serving cell, the network device not monitoring and receiving an uplink transmission from the terminal device or not sending data to the terminal device during the measurement on the to-be-measured inter-frequency reference signal by the terminal device; or in a case that the terminal device is in a frequency range 2 (FR2) system, the network device not monitoring and receiving an uplink transmission from the terminal device or not sending data to the terminal device during the measurement on the to-be-measured inter-frequency reference signal by the terminal device; and performing a scheduling based on the measurement scheduling requirement.

In some examples, the network device not monitoring and receiving an uplink transmission from the terminal device during the measurement on the to-be-measured inter-frequency reference signal by the terminal device includes: not monitoring and receiving, by the network device and at the resource location of the to-be-measured inter-frequency reference signal and at N resource locations before and after the resource location of the to-be-measured inter-frequency reference signal, the uplink transmission from the terminal device; where the network device not sending data to the terminal device during the measurement on the to-be-measured inter-frequency reference signal by the terminal device includes: not sending, by the network device and at the resource location of the to-be-measured inter-frequency reference signal and at N resource locations before and after the resource location of the to-be-measured inter-frequency reference signal, the data to the terminal device.

In some examples, the determining a measurement scheduling requirement includes: determining the measurement scheduling requirement based on a protocol agreement.

In some examples, the network device not monitoring and receiving an uplink transmission from the terminal device includes at least one of: not monitoring or receiving a PUCCH; not monitoring or receiving a PUSCH; or not monitoring or receiving an SRS.

In some examples, the network device not sending data to the terminal device includes at least one of: not sending a PDCCH to the terminal device; not sending a PDSCH to the terminal device; not sending a TRS to the terminal device; or not sending a CSI for CQI to the terminal device.

In some examples, the to-be-measured inter-frequency reference signal includes at least one of: an SSB; a CSI-RS; or a PRS.

In a third aspect, an embodiment of the present disclosure provides a communication apparatus, which is applied to a terminal device and including: a processing module, configured to determine, in response to that an inter-frequency measurement is to be performed on a to-be-measured inter-frequency reference signal, whether the to-be-measured inter-frequency reference signal is to be measured based on a measurement gap.

In a fourth aspect, an embodiment of the present disclosure provides a communication apparatus, which is applied to a network device and including: a transceiver module, configured to receive capability information reported by a terminal device, where the capability information indicates, when a resource location of a to-be-measured inter-frequency reference signal is included within a downlink active bandwidth part (BWP) of a current serving cell of the terminal device, whether the terminal device supports an inter-frequency measurement without a measurement gap; and the transceiver module is further configured to send indication signaling to the terminal device, where the indication signaling indicates whether a measurement gap is necessary for the terminal device to perform the inter-frequency measurement on the to-be-measured inter-frequency reference signal.

In a fifth aspect, an embodiment of the present disclosure provides a communication apparatus, which includes a processor, and when the processor calls a computer program in a memory, the method described in the first aspect is executed.

In a sixth aspect, an embodiment of the present disclosure provides a communication apparatus, which includes a processor, and when the processor calls a computer program in a memory, the method described in the second aspect is executed.

In a seventh aspect, an embodiment of the present disclosure provides a communication apparatus, which includes a processor and a memory, where a computer program is stored in the memory, and the processor executes the computer program stored in the memory to cause the communication apparatus to perform the method described in the first aspect.

In an eighth aspect, an embodiment of the present disclosure provides a communication apparatus, which includes a processor and a memory, where a computer program is stored in the memory, and the processor executes the computer program stored in the memory to cause the communication apparatus to perform the method described in the second aspect.

In a ninth aspect, an embodiment of the present disclosure provides a communication apparatus, which includes a processor and an interface circuit, where the interface circuit is configured to receive code instructions and transmit them to the processor, and the processor is configured to run the code instructions to enable the apparatus to perform the method described in the first aspect.

In a tenth aspect, an embodiment of the present disclosure provides a communication apparatus, which includes a processor and an interface circuit, where the interface circuit is configured to receive code instructions and transmit them to the processor, and the processor is configured to run the code instructions to enable the apparatus to perform the method described in the second aspect.

In an eleventh aspect, an embodiment of the present disclosure provides a communication system, which includes the communication apparatus described in the third aspect to the communication apparatus described in the fourth aspect, or, the system includes the communication apparatus described in the fifth aspect to the communication apparatus described in the sixth aspect, or, the system includes the communication apparatus described in the seventh aspect to the communication apparatus described in the eighth aspect, or, the system includes the communication apparatus described in the ninth aspect to the communication apparatus described in the tenth aspect.

In a twelfth aspect, an embodiment of the present disclosure provides a non-transitory computer-readable storage medium for storing instructions for the network device and/or the terminal device, and when the instructions are executed, causing the terminal device to perform the method described in the first aspect and/or causing the network device to perform the method described in the second aspect.

In a thirteenth aspect, the present disclosure further provides a computer program product including a computer program, which, when run on a computer, causes the computer to perform the method described in any one of the first to second aspects.

In a fourteenth aspect, the present disclosure provides a chip system, which includes at least one processor and an interface, and is configured to support a terminal device to realize the functions related to the method described in the first aspect, and/or, a network device to realize the functions related to the method described in the second aspect, for example, determining or processing at least one of data and information related to the above methods. In a possible design, the chip system further includes a memory, and the memory is configured to store necessary computer programs and data of the source and secondary nodes. The chip system can be composed of chips or include chips and other discrete devices.

In a fifth aspect, the present disclosure provides a computer program which, when run on a computer, causes the computer to perform the method described in any one of the first to second aspects.

### BRIEF DESCRIPTION OF DRAWINGS

The above-mentioned and/or additional aspects and advantages of the present disclosure will be apparent and easily understood from the following description of embodiments taken in conjunction with accompanying drawings.

FIG. 1 is a schematic architectural diagram of a communication system according to an embodiment of the present disclosure.

FIG. 2 is a flowchart of a measurement configuration method according to an embodiment of the present disclosure.

FIG. 3a is a flowchart of a measurement configuration method according to another embodiment of the present disclosure.

FIG. 3b is a flowchart of a measurement configuration method according to another embodiment of the present disclosure.

FIG. 3c is a flowchart of a measurement configuration method according to another embodiment of the present disclosure.

FIG. 4 is a flowchart of a measurement configuration method according to another embodiment of the present disclosure.

FIG. 5 is a flowchart of a measurement configuration method according to another embodiment of the present disclosure.

FIG. 6 is a flowchart of a measurement configuration method according to another embodiment of the present disclosure.

FIG. 7a is a flowchart of a measurement configuration method according to another embodiment of the present disclosure.

FIG. 7b is a flowchart of a measurement configuration method according to another embodiment of the present disclosure.

FIG. 7c is a flowchart of a measurement configuration method according to another embodiment of the present disclosure.

FIG. 8 is a flowchart of a measurement configuration method according to another embodiment of the present disclosure.

FIG. 9 is a flowchart of a measurement configuration method according to another embodiment of the present disclosure.

FIG. 10 is a flowchart of a measurement configuration method according to another embodiment of the present disclosure.

FIG. 11 is a schematic structural diagram of a communication apparatus according to an embodiment of the present disclosure.

FIG. 12 is a schematic structural diagram of a communication apparatus according to another embodiment of from another the present disclosure.

FIG. 13 is a schematic structural diagram of a communication apparatus according to an embodiment of the present disclosure;

FIG. 14 is a schematic structural diagram of a chip according to an embodiment of the present disclosure.

### DETAILED DESCRIPTION

Reference will now be made in detail to embodiments, examples of which are illustrated in the accompanying drawings. When the following description refers to the accompanying drawings, unless otherwise indicated, the same numbers in different accompanying drawings indicate the same or similar elements. Implementations described in the following embodiments do not represent all implementations consistent with the embodiments of the present disclosure. Rather, they are merely examples of apparatuses and methods consistent with some aspects of embodiments of the present disclosure as detailed in the appended claims.

Terms used in embodiments of the present disclosure are only for a purpose of describing specific embodiments, and are not limiting the embodiments of the present disclosure. Singular forms of “a”, said”, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “in a case that” and “if”' as used herein can be interpreted as “at” or “when” or “in response to determining”.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are examples and are intended to explain the present disclosure, and should not be construed as limiting the present disclosure.

In order to better understand an indication method disclosed in embodiments of the present disclosure, a communication system applicable to the embodiments of the present disclosure will be described below.

In order to facilitate understanding, the terms involved in the present disclosure are first introduced.

### Measurement Gap

A time period during which the terminal device may be configured to perform measurements.

### 2. Inter-Frequency Measurement

It means that a cell where the terminal device is currently located and a target cell are not on the same carrier frequency.

### 3. Active Bandwidth Part (Active BWP)

The first BWP where the terminal device starts data transmission after RRC configuration/reconfiguration.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are examples and are intended to explain the present disclosure, and should not be construed as limiting the present disclosure.

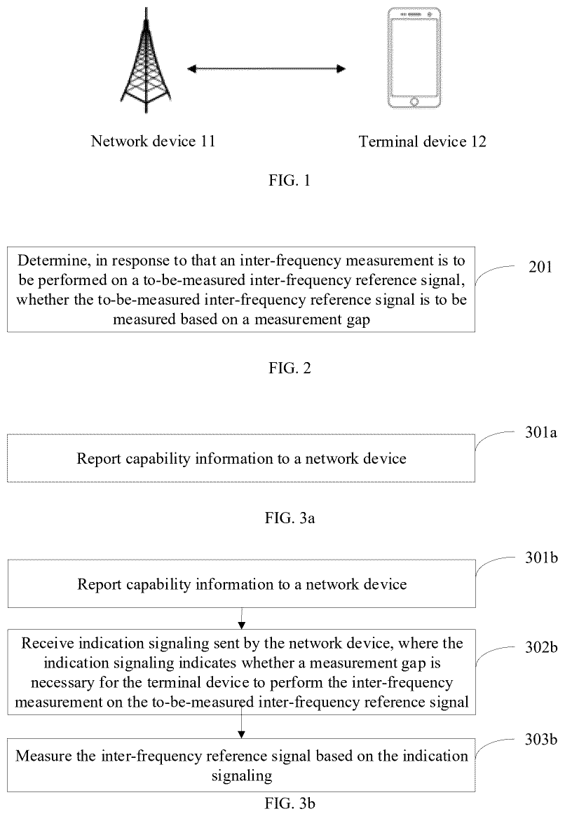

Referring to FIG. 1, FIG. 1 is a schematic architectural diagram of a communication system according to an embodiment of the present disclosure. The communication system may include, but is not limited to, a network device and a terminal device. The number and form of devices shown in FIG. 1 are only for example and do not constitute a limitation to the embodiments of the present disclosure. In practical application, it may include two or more network devices and two or more terminal devices. The communication system shown in FIG. 1 is exemplified by including a network device 11 and a terminal device 12.

It should be noted that the technical solutions of the embodiments of the present disclosure can be applied to various communication systems. For example: a long term evolution (LTE) system, a 5th generation (5G) mobile communication system, a 5G new radio (NR) system, or other future new mobile communication systems.

The network device 11 in the embodiment of the present disclosure is an entity on a network side for transmitting or receiving signals. For example, the network device 11 may be an evolved NodeB (eNB), a transmission reception point (TRP), a next generation NodeB (gNB) in an NR system, a base station in other future mobile communication systems or an access node in a wireless fidelity (WiFi) system. The embodiments of the present disclosure do not limit specific technologies and specific device forms adopted by the network device. The network device provided by the embodiment of the present disclosure may be composed of a central unit (CU) and a distributed unit (DU), where CU may also be named as a control unit. With a structure of CU-DU, protocol layers of a network device, such as a base station, can be separated, and some functions of the protocol layers are centralized controlled by CU, while some or all functions of the remaining protocol layers are distributed in DU, which is centralized controlled by CU.

The terminal device 12 in the embodiment of the present disclosure is an entity, such as a mobile phone, on a user side for receiving or transmitting signals. The terminal device may also be named as a terminal, a user equipment (UE), a mobile station (MS), a mobile terminal (MT) and so on. The terminal device can be a car with communication function, a smart car, a mobile phone, a wearable device, a Pad, a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit specific technologies and specific device forms adopted by the terminal device.

It is to be understood that the communication system described in the embodiments of the present disclosure is intended to more clearly illustrate the technical solutions of the embodiments of the present disclosure and does not constitute a limitation of the technical solutions provided by the embodiments of the present disclosure, and a person of ordinary skill in the art may know that, with an evolution of a system architecture and an emergence of a new business scenario, the technical solutions provided by the embodiments of the present disclosure are equally applicable to similar technical problems.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are examples and are intended to explain the present disclosure, and should not be construed as limiting the present disclosure.

FIG. 2 is a flowchart of a measurement configuration method according to an embodiment of the present disclosure, which is performed by a terminal device. As shown in FIG. 2, the measurement configuration method may include step 201.

At step 201, determining, in response that to an inter-frequency measurement is to be performed on a to-be-measured inter-frequency reference signal, whether the to-be-measured inter-frequency reference signal is to be measured based on a measurement gap.

In an embodiment of the present disclosure, the to-be-measured inter-frequency reference signal may include at least one of the following: a Synchronization Signal Block (SSB); a Channel State Information-Reference Signal (CSI-RS); or a Positioning Reference Signal (PRS).

Moreover, in an embodiment of the present disclosure, since a measurement gap is not necessary for some inter-frequency measurements, when performing an inter-frequency measurement on the to-be-measured inter-frequency reference signal, it is first determined whether a measurement gap is necessary for the inter-frequency measurement. This allows, when it is determined that a measurement gap is not necessary for the inter-frequency measurement, the inter-frequency measurement on the to-be-measured inter-frequency reference signal can be performed without relying on a measurement gap, thereby avoiding the situation where “an inter-frequency measurement that does not require the use of measurement gap is also performed based on the measurement gap”. This can reduce the interruption between the terminal device and the current serving cell and improve the throughput of the terminal device.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

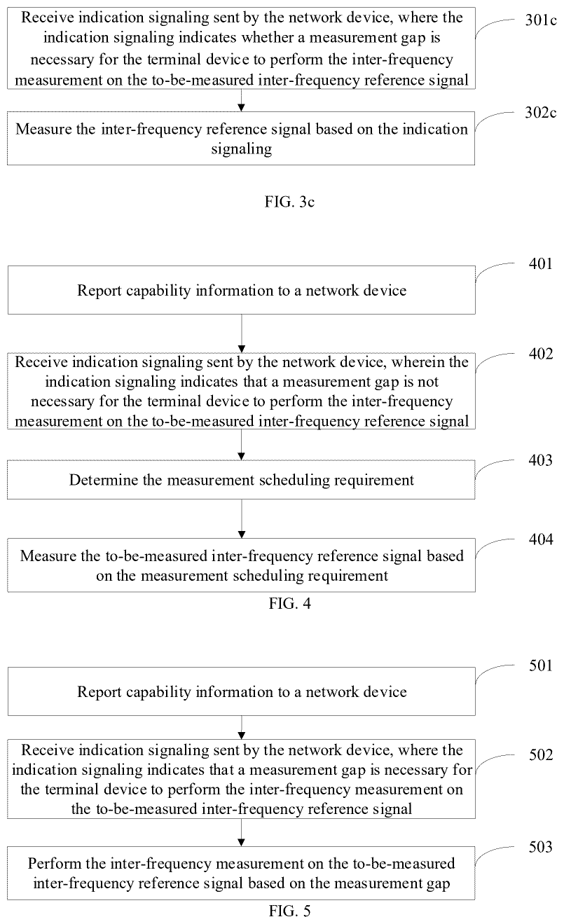

FIG. 3a is a flowchart of a measurement configuration method according to an embodiment of the present disclosure, which is performed by a terminal device. As shown in FIG. 3a, the measurement configuration method may include step 301a.

At step 301a, reporting capability information to a network device.

In an embodiment of the present disclosure, the capability information indicates, when a resource location of to-be-measured inter-frequency reference signal is included within a downlink active bandwidth part (BWP) of a current serving cell of the terminal device, whether the terminal device supports an inter-frequency measurement without the measurement gap.

In an embodiment of the present disclosure, the resource location of the to-be-measured inter-frequency reference signal is specifically obtained by the terminal device based on configuration information of a measurement object configured by the network device. The configuration information of the measurement object specifically includes time-frequency domain resources, transmission period and other information of the to-be-measured inter-frequency reference signal.

In addition, in an embodiment of the present disclosure, the above-mentioned “an inter-frequency measurement without the measurement gap” specifically means that it is not necessary to measure the to-be-measured inter-frequency reference signal in the measurement gap, that is, it is not necessary to interrupt a communication between the terminal device and the current serving cell when measuring the to-be-measured inter-frequency reference signal, in other words, it is possible to synchronously measure the to-be-measured inter-frequency reference signal during the communication between the terminal device and the current serving cell.

Further, in an embodiment of the present disclosure, a resource location of to-be-measured inter-frequency reference signal is included within a downlink active BWP of a current serving cell of the terminal device, which can be understood as: the terminal device can receive a to-be-measured inter-frequency reference signal of a to-be-measured cell via the downlink active BWP in the current serving cell. Based on this, when the to-be-measured inter-frequency reference signal is to be measured, the to-be-measured inter-frequency reference signal can be directly received in the downlink active BWP of the current serving cell and measured without interrupting communication with the current serving cell, i.e., there is no need to the measurement gap. Therefore, when a resource location of a to-be-measured inter-frequency reference signal is included in a downlink active BWP of the current serving cell of the terminal device, it means that the to-be-measured inter-frequency reference signal is a signal that does not need to be measured using the measurement gap, so that the terminal device needs to report to the network device its capability information regarding whether it supports an inter-frequency measurement without requiring the measurement gap. This allows the network device to configure the inter-frequency measurement without requiring the measurement gap based on the capability information subsequently.

In addition, in an embodiment of the present disclosure, the “whether the terminal device supports an inter-frequency measurement without the measurement gap” may be determined by the terminal device based on a baseband processing capability of the terminal device.

In addition, in an embodiment of the present disclosure, the terminal device may report the capability information to the network device through radio resource control (RRC) signaling. The RRC signaling may be IE MeasAndMobParameters signaling.

To sum up, in the measurement configuration method provided by the embodiment of the present disclosure, the terminal device will report the capability information to the network device, so that the network device can subsequently indicate whether a measurement gap is necessary for the terminal device to measure the to-be-measured inter-frequency reference. That is, in the present disclosure, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 3b is a flowchart of a measurement configuration method according to an embodiment of the present disclosure, which is performed by a terminal device. As shown in FIG. 3b, the measurement configuration method may include steps 301b-303b.

At step 301b, reporting capability information to a network device.

In an embodiment of the present disclosure, the capability information indicates, when a resource location of to-be-measured inter-frequency reference signal is included within a downlink active bandwidth part (BWP) of a current serving cell of the terminal device, whether the terminal device supports an inter-frequency measurement without the measurement gap.

In an embodiment of the present disclosure, the resource location of the to-be-measured inter-frequency reference signal is specifically obtained by the terminal device based on configuration information of a measurement object configured by the network device. The configuration information of the measurement object specifically includes time-frequency domain resources, transmission period and other information of the to-be-measured inter-frequency reference signal.

In addition, in an embodiment of the present disclosure, the above-mentioned “an inter-frequency measurement without the measurement gap” specifically means that it is not necessary to measure the to-be-measured inter-frequency reference signal in the measurement gap, that is, it is not necessary to interrupt a communication between the terminal device and the current serving cell when measuring the to-be-measured inter-frequency reference signal, in other words, it is possible to synchronously measure the to-be-measured inter-frequency reference signal during the communication between the terminal device and the current serving cell.

Further, in an embodiment of the present disclosure, a resource location of to-be-measured inter-frequency reference signal is included within a downlink active BWP of a current serving cell of the terminal device, which can be understood as: the terminal device can receive a to-be-measured inter-frequency reference signal of a to-be-measured cell via the downlink active BWP in the current serving cell. Based on this, when the to-be-measured inter-frequency reference signal is to be measured, the to-be-measured inter-frequency reference signal can be directly received in the downlink active BWP of the current serving cell and measured without interrupting communication with the current serving cell, i.e., there is no need to the measurement gap. Therefore, when a resource location of a to-be-measured inter-frequency reference signal is included in a downlink active BWP of the current serving cell of the terminal device, it means that the to-be-measured inter-frequency reference signal is a signal that does not need to be measured using the measurement gap, so that the terminal device needs to report to the network device its capability information regarding whether it supports an inter-frequency measurement without requiring the measurement gap. This allows the network device to configure the inter-frequency measurement without requiring the measurement gap based on the capability information subsequently.

In addition, in an embodiment of the present disclosure, the “whether the terminal device supports an inter-frequency measurement without the measurement gap” may be determined by the terminal device based on a baseband processing capability of the terminal device.

In addition, in an embodiment of the present disclosure, the terminal device may report the capability information to the network device through RRC signaling. The RRC signaling may be IE MeasAndMobParameters signaling.

At step 302b, receiving indication signaling sent by the network device, where the indication signaling indicates whether a measurement gap is necessary for the terminal device to perform the inter-frequency measurement on the to-be-measured inter-frequency reference signal.

In an embodiment of the present disclosure, the network device may send indication signaling to the terminal device according to the capability information reported by the terminal device, which is used to configure an inter-frequency measurement mode of the to-be-measured inter-frequency reference signal.

In an embodiment of the present disclosure, in response to an indication in the capability information reported by the terminal device indicating that when the resource location of to-be-measured inter-frequency reference signal is included within the downlink active BWP of the current serving cell of the terminal device, the terminal device supports the inter-frequency measurement without the measurement gap, and the indication signaling received by the terminal device may indicate that a measurement gap is not necessary for the terminal device to perform the inter-frequency measurement on the to-be-measured inter-frequency reference signal. In this case, the indication signaling may be, for example, a flag interFrequencyConfig-NoGap signaling.

In another embodiment of the present disclosure, in response to an indication in the capability information reported by the terminal device indicating that when the resource location of to-be-measured inter-frequency reference signal is included within the downlink active BWP of the current serving cell of the terminal device, the terminal device supports the inter-frequency measurement without the measurement gap, and the indication signaling received by the terminal device may indicate that a measurement gap is necessary for the terminal device to perform the inter-frequency measurement on the to-be-measured inter-frequency reference signal. That is, even if the terminal device supports an inter-frequency measurement without the measurement gap, the network device may still configure that the terminal device needs to perform the inter-frequency measurement on the to-be-measured inter-frequency reference signal based on the measurement gap.

In yet another embodiment of the present disclosure, in response to an indication in the capability information reported by the terminal device indicating that when the resource location of to-be-measured inter-frequency reference signal is included within the downlink active BWP of the current serving cell of the terminal device, the terminal device does not support the inter-frequency measurement without the measurement gap, and the indication signaling received by the terminal device may indicate that a measurement gap is necessary for the terminal device to perform the inter-frequency measurement on the to-be-measured inter-frequency reference signal.

In addition, in an embodiment of the present disclosure, the terminal device may specifically receive the indication signaling sent by the network device through RRC signaling.

At step 303b, measuring the inter-frequency reference signal based on the indication signaling.

In an embodiment of the present disclosure, when the content indicated by the indication signaling is different, the inter-frequency measurement process performed by the terminal device on the to-be-measured inter-frequency reference signal is also different. This part will be described in detail in the following embodiments.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 3c is a flowchart of a measurement configuration method according to an embodiment of the present disclosure, which is performed by a terminal device. As shown in FIG. 3c, the measurement configuration method may include steps 301c and 302c.

At step 301c, receiving indication signaling sent by the network device, where the indication signaling indicates whether a measurement gap is necessary for the terminal device to perform the inter-frequency measurement on the to-be-measured inter-frequency reference signal.

In an embodiment of the present disclosure, the network device may send indication signaling to the terminal device to configure an inter-frequency measurement mode of the to-be-measured inter-frequency reference signal.

In an embodiment of the present disclosure, the indication signaling may indicate that a measurement gap is not necessary for the terminal device to perform the inter-frequency measurement on the to-be-measured inter-frequency reference signal. In this case, the indication signaling may be, for example, a flag interFrequencyConfig-NoGap signaling.

In another embodiment of the present disclosure, the indication signaling may indicate that a measurement gap is necessary for the terminal device to perform the inter-frequency measurement on the to-be-measured inter-frequency reference signal.

In addition, in an embodiment of the present disclosure, the terminal device may specifically receive the indication signaling sent by the network device through RRC signaling.

At step 302c, measuring the inter-frequency reference signal based on the indication signaling.

The method for the terminal device to measure the to-be-measured inter-frequency reference signal based on the indication signaling may include any one of the following.

In an embodiment of the present disclosure, when the indication signaling indicates that a measurement gap is necessary for the terminal device to perform the inter-frequency measurement on the to-be-measured inter-frequency reference signal, the terminal device will subsequently perform the inter-frequency measurement based on the measurement gap.

In another embodiment of the present disclosure, the indication signaling may indicate that a measurement gap is not necessary for the terminal device to perform the inter-frequency measurement on the to-be-measured inter-frequency reference signa, the terminal device can directly determine a measurement scheduling requirement and measure the inter-frequency reference signal based on the measurement scheduling requirement. Detailed introductions regarding how the terminal device determines the measurement scheduling requirement and what the measurement scheduling requirement specifically include will be provided in subsequent embodiments.

In yet another embodiment of the present disclosure, when the indication signaling indicates that a measurement gap is not necessary for the terminal device to perform the inter-frequency measurement on the to-be-measured inter-frequency reference signal, the terminal device can determine whether to perform the inter-frequency measurement without a measurement gap based on its capabilities. If the terminal device supports performing the inter-frequency measurement on the to-be-measured inter-frequency reference signal without a measurement gap, it will subsequently perform the inter-frequency measurement on the to-be-measured inter-frequency reference signal without the measurement gap. If the terminal device does not support performing the inter-frequency measurement on the to-be-measured inter-frequency reference signal without a measurement gap, the terminal device needs to perform the inter-frequency measurement on the to-be-measured inter-frequency reference signal based on the measurement gap subsequently.

To sum up, in the measurement configuration method provided by the embodiment of the present disclosure, the terminal device determines whether the to-be-measured inter-frequency reference is to be measured based on the measurement gap based on its own capabilities and the indication signaling sent by the network device. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 4 is a flowchart of a measurement configuration method according to an embodiment of the present disclosure, which is performed by a terminal device. As shown in FIG. 4, the measurement configuration method may include steps 401-404.

At step 401, reporting capability information to a network device.

At step 402, receiving indication signaling sent by the network device, where the indication signaling indicates that a measurement gap is not necessary for the terminal device to perform the inter-frequency measurement on the to-be-measured inter-frequency reference signal.

For detailed introductions to steps 401-402, please refer to the descriptions of the above embodiments.

At step 403, determining the measurement scheduling requirement.

In an embodiment of the present disclosure, the terminal device may determine the measurement scheduling requirement based on a protocol agreement.

And, in an embodiment of the present disclosure, the measurement scheduling requirement may include at least one of the following.

First, in a case that the terminal device is in a time division duplexing (TDD) bandwidth, the terminal device does not perform an uplink transmission during the measurement on the to-be-measured inter-frequency reference signal.

In an embodiment of the present disclosure, the terminal device does not perform an uplink transmission during the measurement on the to-be-measured inter-frequency reference signal, which can be understood as: the terminal device measures the inter-frequency reference signal but does not perform the uplink transmission at the resource location of the to-be-measured inter-frequency reference signal and at N resource locations before and after the resource location of the to-be-measured inter-frequency reference signal, where N may be 1. The resource location may be an orthogonal frequency division multiplexing (OFDM) symbol.

In an embodiment of the present disclosure, the uplink transmission may include at least one of the following: sending a physical uplink control channel (PUCCH); sending a physical uplink shared channel (PUSCH); or sending a sounding reference signal (SRS).

It should be noted that the uplink transmission may specifically be: an uplink transmission between the terminal device and the current serving cell.

Second, in a case that a sub-carrier spacing (SCS) of the to-be-measured inter-frequency reference signal is different from a SCS of data and/or signal in the current serving cell, the terminal device does not perform an uplink transmission or a downlink reception during the measurement on the to-be-measured inter-frequency reference signal.

In an embodiment of the present disclosure, the terminal device does not perform an uplink transmission or a downlink reception during the measurement on the to-be-measured inter-frequency reference signal, which can be understood as: the terminal device measures the inter-frequency reference signal but does not perform the uplink transmission or downlink reception at the resource location of the to-be-measured inter-frequency reference signal and at N resource locations before and after the resource location of the to-be-measured inter-frequency reference signal, where N may be 1. The resource location may be an OFDM symbol.

For detailed introductions to uplink transmission, please refer to the above descriptions.

In an embodiment of the present disclosure, the downlink reception may include at least one of the following: receiving a physical downlink control channel (PDCCH); receiving a physical downlink shared channel (PDSCH); receiving a tracking reference signal (TRS); or receiving a channel state information-reference signal (CSI-RS) for channel quality indicator (CQI).

It should be noted that the downlink reception may specifically be: a downlink reception between the terminal device and the current serving cell.

Third, in a case that the terminal device is in a frequency range 2 (FR2) system, the terminal device does not perform an uplink transmission or a downlink reception during the measurement on the to-be-measured inter-frequency reference signal.

For detailed introductions to the third measurement scheduling requirement, please refer to the above descriptions.

According to the measurement scheduling requirement, the essence of the measurement scheduling requirements is: during a measurement on the to-be-measured inter-frequency reference signal, the terminal device can choose one from “uplink transmission or downlink reception”. In other words, during the measurement on the to-be-measured inter-frequency reference signal, the terminal device can perform uplink transmission or downlink reception. That is, during the measurement on the to-be-measured inter-frequency reference signal, the terminal device can still maintain a communication with the current serving cell without interruption. In other words, the terminal device performs the inter-frequency measurement without relying on the measurement gap.

At step 404, measuring the to-be-measured inter-frequency reference signal based on the measurement scheduling requirement.

In an embodiment of the present disclosure, the “measuring the to-be-measured inter-frequency reference signal based on the measurement scheduling requirement” may mainly include at least one of the following.

In response to the terminal device is in a TDD bandwidth, the terminal device does not perform an uplink transmission during the measurement on the to-be-measured inter-frequency reference signal. That is, the terminal device measures the inter-frequency reference signal but does not perform the uplink transmission at the resource location of the to-be-measured inter-frequency reference signal and at N resource locations before and after the resource location of the to-be-measured inter-frequency reference signal.

In response to a sub-carrier spacing (SCS) of the to-be-measured inter-frequency reference signal is different from a SCS of data and/or signal in the current serving cell, the terminal device does not perform an uplink transmission or a downlink reception during the measurement on the to-be-measured inter-frequency reference signal. That is, the terminal device measures the inter-frequency reference signal but does not perform the uplink transmission or downlink reception at the resource location of the to-be-measured inter-frequency reference signal and at N resource locations before and after the resource location of the to-be-measured inter-frequency reference signal.

In response to the terminal device is in a FR2 system, the terminal device does not perform an uplink transmission or a downlink reception during the measurement on the to-be-measured inter-frequency reference signal. That is, the terminal device measures the inter-frequency reference signal but does not perform the uplink transmission or downlink reception at the resource location of the to-be-measured inter-frequency reference signal and at N resource locations before and after the resource location of the to-be-measured inter-frequency reference signal.

Therefore, it can be seen from the above content that when measuring the to-be-measured inter-frequency reference signal based on the measurement scheduling requirement, the terminal device performs the inter-frequency measurement without relying on a measurement gap. That is, during the measurement on the to-be-measured inter-frequency reference signal, the terminal device can still maintain a communication with the current serving cell without interruption. This can reduce the interruption between the terminal device and the current serving cell and improve the throughput of the terminal device.

In addition, it should be noted that in an embodiment of present disclosure, when the terminal device measures the to-be-measured inter-frequency reference signal, the measurement can be specifically based on configuration information of a measurement object corresponding to the to-be-measured inter-frequency reference signal. The configuration information of the measurement object specifically includes time-frequency domain resources, transmission period and other information of the to-be-measured inter-frequency reference signal. The terminal device can receive the to-be-measured inter-frequency reference signal based on the configuration information of the measurement object and perform measurement.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 5 is a flowchart of a measurement configuration method according to an embodiment of the present disclosure, which is performed by a terminal device. As shown in FIG. 5, the measurement configuration method may include steps 501-503.

At step 501, reporting capability information to a network device.

At step 502, receiving indication signaling sent by the network device, where the indication signaling indicates that a measurement gap is necessary for the terminal device to perform the inter-frequency measurement on the to-be-measured inter-frequency reference signal.

For detailed introductions to steps 501-502, please refer to the descriptions of the above embodiments.

At step 503, performing the inter-frequency measurement on the to-be-measured inter-frequency reference signal based on the measurement gap.

In an embodiment of the present disclosure, the measurement gap specifically includes parameter information such as a period, duration, offset, and measurement gap timing advance value. And, the terminal device can measure the to-be-measured inter-frequency reference signal based on the parameter information included in the measurement gap.

In an embodiment of the present disclosure, when the terminal device measures the to-be-measured inter-frequency reference signal based on the parameter information included in the measurement gap, the measurement may be specifically based on the measurement gap and the configuration information of a measurement object corresponding to the to-be-measured inter-frequency reference signal. The configuration information of the measurement object specifically includes time-frequency domain resources, transmission period and other information of the to-be-measured inter-frequency reference signal. And, the terminal device can receive the to-be-measured inter-frequency reference signal based on the configuration information of the measurement object and measuring the to-be-measured inter-frequency reference signal based on the measurement gap. Detailed methods for measuring the to-be-measured inter-frequency reference signal based on the measurement gap can be described with reference to the related art.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

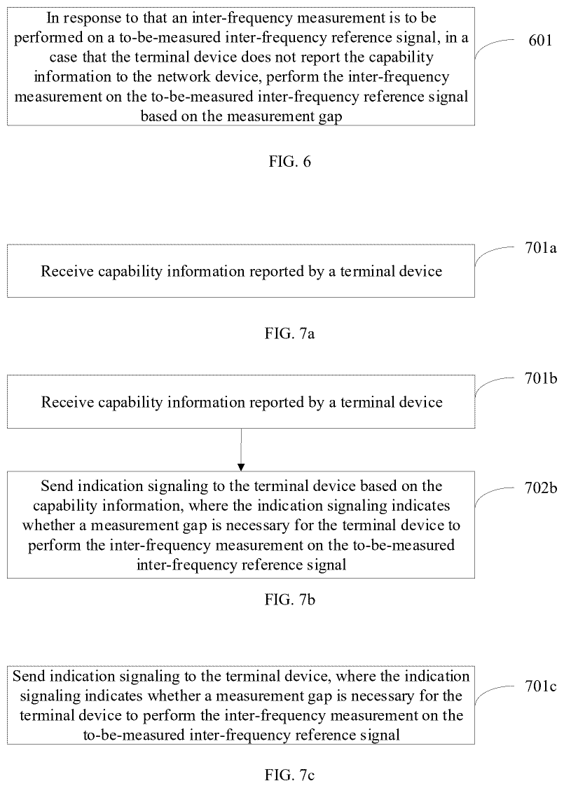

FIG. 6 is a flowchart of a measurement configuration method according to an embodiment of the present disclosure, which is performed by a terminal device. As shown in FIG. 6, the measurement configuration method may include step 601.

At step 601, in response to that an inter-frequency measurement is to be performed on a to-be-measured inter-frequency reference signal, in a case that the terminal device does not report the capability information to the network device, performing the inter-frequency measurement on the to-be-measured inter-frequency reference signal based on the measurement gap.

The related introduction of step 601 can be described with reference to the above embodiments, and the embodiment of the present disclosure is not repeated here.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 7a is a flowchart of a measurement configuration method according to an embodiment of the present disclosure, which is performed by a network device. As shown in FIG. 7a, the measurement configuration method may include step 701a.

At step 701a, receiving capability information reported by a terminal device.

The capability information indicates. when a resource location of a to-be-measured inter-frequency reference signal is included within a downlink active bandwidth part (BWP) of a current serving cell of the terminal device, whether the terminal device supports an inter-frequency measurement without a measurement gap.

The detailed description of the step 701a can be described with reference to the above embodiments.

To sum up, in the measurement configuration method provided by the embodiment of the present disclosure, the network device receives the capability information sent by the terminal device, which indicates whether the terminal device supports the inter-frequency measurement without the measurement gap when the resource location of the to-be-measured inter-frequency reference signal is included within the downlink active BWP of the current serving cell of the terminal device, the network device determines, based on the capability information, whether a measurement gap is necessary for the terminal device to perform the inter-frequency measurement, and indicates to the terminal device. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 7b is a flowchart of a measurement configuration method according to an embodiment of the present disclosure, which is performed by a network device. As shown in FIG. 7b, the measurement configuration method may include steps 701b and 702b.

At step 701b, receiving capability information reported by a terminal device.

The capability information indicates. when a resource location of a to-be-measured inter-frequency reference signal is included within a downlink active bandwidth part (BWP) of a current serving cell of the terminal device, whether the terminal device supports an inter-frequency measurement without a measurement gap.

At step 702b, sending indication signaling to the terminal device based on the capability information, where the indication signaling indicates whether a measurement gap is necessary for the terminal device to perform the inter-frequency measurement on the to-be-measured inter-frequency reference signal.

The detailed description of the steps 701b-702b can be described with reference to the above embodiments.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 7c is a flowchart of a measurement configuration method according to an embodiment of the present disclosure, which is performed by a network device. As shown in FIG. 7c, the measurement configuration method may include step 701c.

At step 701c, sending indication signaling to the terminal device, where the indication signaling indicates whether a measurement gap is necessary for the terminal device to perform the inter-frequency measurement on the to-be-measured inter-frequency reference signal.

The detailed description of the step 701c can be described with reference to the above embodiments.

To sum up, in the measurement configuration method provided by the embodiment of the present disclosure, the network device sends the indication signaling to the terminal device to indicate whether a measurement gap is necessary for the terminal device to measure the to-be-measured inter-frequency reference. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

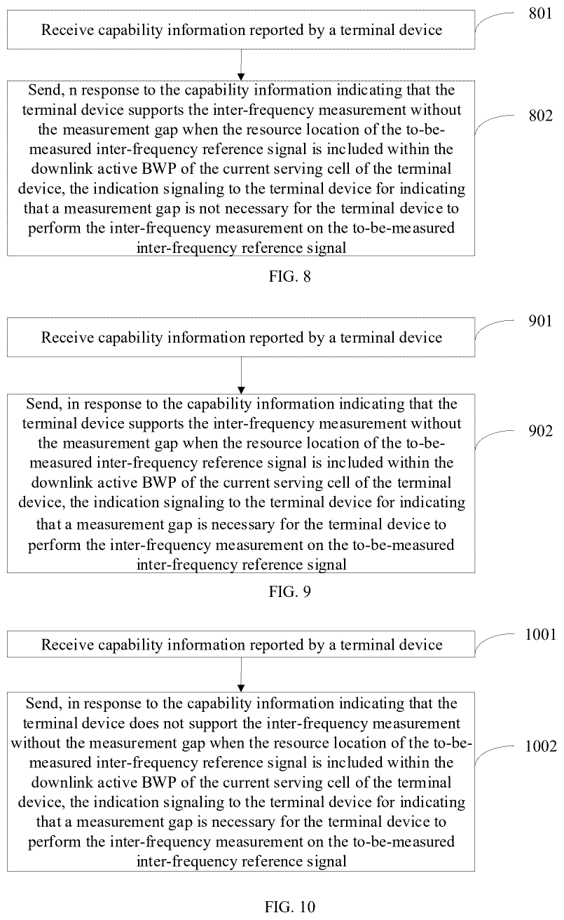

FIG. 8 is a flowchart of a measurement configuration method according to an embodiment of the present disclosure, which is performed by a network device. As shown in FIG. 8, the measurement configuration method may include steps 801-802.

At step 801, receiving capability information reported by a terminal device.

The capability information indicates, when a resource location of a to-be-measured inter-frequency reference signal is included within a downlink active bandwidth part (BWP) of a current serving cell of the terminal device, whether the terminal device supports an inter-frequency measurement without a measurement gap.

At step 802, sending, in response to the capability information indicating that the terminal device supports the inter-frequency measurement without the measurement gap when the resource location of the to-be-measured inter-frequency reference signal is included within the downlink active BWP of the current serving cell of the terminal device, the indication signaling to the terminal device for indicating that a measurement gap is not necessary for the terminal device to perform the inter-frequency measurement on the to-be-measured inter-frequency reference signal.

For detailed introductions to the steps 801-802, please refer to the descriptions of the above embodiments.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 9 is a flowchart of a measurement configuration method according to an embodiment of the present disclosure, which is performed by a network device. As shown in FIG. 9, the measurement configuration method may include steps 901-902.

At step 901, receiving capability information reported by a terminal device.

The capability information indicates, when a resource location of a to-be-measured inter-frequency reference signal is included within a downlink active bandwidth part (BWP) of a current serving cell of the terminal device, whether the terminal device supports an inter-frequency measurement without a measurement gap.

At step 902, sending, in response to the capability information indicating that the terminal device supports the inter-frequency measurement without the measurement gap when the resource location of the to-be-measured inter-frequency reference signal is included within the downlink active BWP of the current serving cell of the terminal device, the indication signaling to the terminal device for indicating that a measurement gap is necessary for the terminal device to perform the inter-frequency measurement on the to-be-measured inter-frequency reference signal.

For detailed introductions to the steps 901-902, please refer to the descriptions of the above embodiments.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

FIG. 10 is a flowchart of a measurement configuration method according to an embodiment of the present disclosure, which is performed by a network device. As shown in FIG. 10, the measurement configuration method may include steps 1001 and 1002.

At step 1001, receiving capability information reported by a terminal device.

The capability information indicates, when a resource location of a to-be-measured inter-frequency reference signal is included within a downlink active bandwidth part (BWP) of a current serving cell of the terminal device, whether the terminal device supports an inter-frequency measurement without a measurement gap.

At step 1002, sending, in response to the capability information indicating that the terminal device does not support the inter-frequency measurement without the measurement gap when the resource location of the to-be-measured inter-frequency reference signal is included within the downlink active BWP of the current serving cell of the terminal device, the indication signaling to the terminal device for indicating that a measurement gap is necessary for the terminal device to perform the inter-frequency measurement on the to-be-measured inter-frequency reference signal.

For detailed introductions to the steps 1001-1002, please refer to the descriptions of the above embodiments.

To sum up, in the measurement configuration method provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

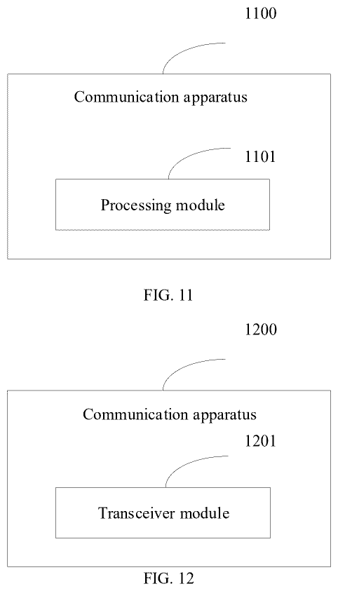

FIG. 11 is a schematic structural diagram of a communication apparatus 1100 according to an embodiment of the present disclosure. As shown in FIG. 11, the apparatus may include: a processing module 1101, configured to determine, in response to that an inter-frequency measurement is to be performed on a to-be-measured inter-frequency reference signal, whether the to-be-measured inter-frequency reference signal is to be measured based on a measurement gap.

To sum up, in the communication apparatus provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

In some examples, in an embodiment of the present disclosure, the apparatus is further configured to: report capability information to a network device, where the capability information indicates, when a resource location of the to-be-measured inter-frequency reference signal is comprised within a downlink active bandwidth part (BWP) of a current serving cell of the terminal device, whether the terminal device supports an inter-frequency measurement without the measurement gap.

In some examples, in an embodiment of the present disclosure, the processing module 1101 is further configured to: receive indication signaling sent by the network device, where the indication signaling indicates whether a measurement gap is necessary for the terminal device to perform the inter-frequency measurement on the to-be-measured inter-frequency reference signal; and measure the inter-frequency reference signal based on the indication signaling.

In some examples, in an embodiment of the present disclosure, the processing module 1101 is further configured to: determine, in response to the indication signaling indicating that a measurement gap is not necessary for the terminal device to perform the inter-frequency measurement on the to-be-measured inter-frequency reference signal, which includes at least one of: in a case that the terminal device is in a time division duplexing (TDD) bandwidth, the terminal device not performing an uplink transmission during the measurement on the to-be-measured inter-frequency reference signal; in a case that a sub-carrier spacing (SCS) of the to-be-measured inter-frequency reference signal is different from a SCS of data and/or signal in the current serving cell, the terminal device not performing an uplink transmission or a downlink reception during the measurement on the to-be-measured inter-frequency reference signal; or in a case that the terminal device is in a frequency range 2 (FR2) system, the terminal device not performing an uplink transmission or a downlink reception during the measurement on the to-be-measured inter-frequency reference signal; and measure the to-be-measured inter-frequency reference signal based on the measurement scheduling requirement.

In some examples, in an embodiment of the present disclosure, the terminal device not performing uplink transmission during the measurement on the to-be-measured inter-frequency reference signal includes: measuring, by the terminal device and at the resource location of the to-be-measured inter-frequency reference signal and at N resource locations before and after the resource location of the to-be-measured inter-frequency reference signal, the inter-frequency reference signal but not performing the uplink transmission.

Where the terminal device not performing a downlink reception during the measurement on the to-be-measured inter-frequency reference signal includes: measuring, by the terminal device and at the resource location of the to-be-measured inter-frequency reference signal and at N resource locations before and after the resource location of the to-be-measured inter-frequency reference signal, the inter-frequency reference signal but not performing the downlink reception.

In some examples, in an embodiment of the present disclosure, the processing module 1100 is further configured to: determine the measurement scheduling requirement based on a protocol agreement.

In some examples, in an embodiment of the present disclosure, the uplink transmission includes at least one of the following: send a physical uplink control channel (PUCCH); send a physical uplink shared channel (PUSCH); or send a sounding reference signal (SRS).

In some examples, in an embodiment of the present disclosure, the downlink transmission includes at least one of the following: receive a physical downlink control channel (PDCCH); receive a physical downlink shared channel (PDSCH); receive a tracking reference signal (TRS); or receive a channel state information-reference signal (CSI-RS) for channel quality indicator (CQI).

In some examples, in an embodiment of the present disclosure, the processing module 1101 is further configured to: perform, in response to the indication signaling indicating that a measurement gap is necessary for the terminal device to perform the inter-frequency measurement on the to-be-measured inter-frequency reference signal, the inter-frequency measurement on the to-be-measured inter-frequency reference signal based on the measurement gap.

In some examples, in an embodiment of the present disclosure, the processing module 1100 is further configured to: perform, in a case that the terminal device does not report the capability information to the network device, the inter-frequency measurement on the to-be-measured inter-frequency reference signal based on the measurement gap.

In an embodiment of the present disclosure, the to-be-measured inter-frequency reference signal includes at least one of the following: an SSB; a CSI-RS; or a PRS.

FIG. 12 is a schematic structural diagram of a communication apparatus 1200 according to an embodiment of the present disclosure. As shown in FIG. 12, the apparatus may include: a transceiver module 1201, configured to receive capability information reported by a terminal device, where the capability information indicates, when a resource location of a to-be-measured inter-frequency reference signal is comprised within a downlink active bandwidth part (BWP) of a current serving cell of the terminal device, whether the terminal device supports an inter-frequency measurement without a measurement gap.

To sum up, in the communication apparatus provided by the embodiment of the present disclosure, it is determined whether the to-be-measured inter-frequency reference signal is to be measured based on the measurement gap in response to that the inter-frequency measurement is to be performed on the to-be-measured inter-frequency reference signal. That is, in the present disclosure, before performing the inter-frequency measurement on the to-be-measured inter-frequency reference signal, there is a judgment process to determine whether the inter-frequency measurement needs to be performed based on the measurement gap (for example, for inter-frequency measurements that do not require the measurement gap, the inter-frequency measurements are not performed based on the measurement gap). It is not the case that all inter-frequency measurements are defaulted to be performed based on the measurement gap. This avoids the situation where “an inter-frequency measurement that does not require the use of measurement gap is also performed based on the measurement gap”, reduces the interruption between the terminal device and the current serving cell, and improves the throughput of the terminal device.

In some examples, in an embodiment of the present disclosure, the apparatus is further configured to: send indication signaling to the terminal device, where the indication signaling indicates whether a measurement gap is necessary for the terminal device to perform the inter-frequency measurement on the to-be-measured inter-frequency reference signal.

In some examples, in an embodiment of the present disclosure, the transceiver module 1201 is further configured to: send, in response to the capability information indicating that the terminal device supports the inter-frequency measurement without the measurement gap when the resource location of the to-be-measured inter-frequency reference signal is included within the downlink active BWP of the current serving cell of the terminal device, the indication signaling to the terminal device for indicating that a measurement gap is not necessary for the terminal device to perform the inter-frequency measurement on the to-be-measured inter-frequency reference signal.

In some examples, in an embodiment of the present disclosure, the transceiver module 1201 is further configured to: send, in response to the capability information indicating that the terminal device supports the inter-frequency measurement without the measurement gap when the resource location of the to-be-measured inter-frequency reference signal is included within the downlink active BWP of the current serving cell of the terminal device, the indication signaling to the terminal device for indicating that a measurement gap is necessary for the terminal device to perform the inter-frequency measurement on the to-be-measured inter-frequency reference signal.

In some examples, in an embodiment of the present disclosure, the transceiver module 1201 is further configured to: send, in response to the capability information indicating that the terminal device does not support the inter-frequency measurement without the measurement gap when the resource location of the to-be-measured inter-frequency reference signal is included within the downlink active BWP of the current serving cell of the terminal device, the indication signaling to the terminal device for indicating that a measurement gap is necessary for the terminal device to perform the inter-frequency measurement on the to-be-measured inter-frequency reference signal.

In some examples, in an embodiment of the present disclosure, the apparatus is further configured to: determine a measurement scheduling requirement, where the measurement scheduling requirement includes at least one of: in a case that the terminal device is in a time division duplexing (TDD) bandwidth, the network device not monitoring and receiving an uplink transmission from the terminal device during a measurement on the to-be-measured inter-frequency reference signal by the terminal device; in a case that a sub-carrier spacing (SCS) of the to-be-measured inter-frequency reference signal is different from a SCS of data and/or signal in the current serving cell, the network device not monitoring and receiving an uplink transmission from the terminal device or not sending data to the terminal device during the measurement on the to-be-measured inter-frequency reference signal by the terminal device; or in a case that the terminal device is in a frequency range 2 (FR2) system, the network device not monitoring and receiving an uplink transmission from the terminal device or not sending data to the terminal device during the measurement on the to-be-measured inter-frequency reference signal by the terminal device; and perform a scheduling based on the measurement scheduling requirement.

In some examples, in an embodiment of the present disclosure, the network device not monitoring and receiving an uplink transmission from the terminal device during the measurement on the to-be-measured inter-frequency reference signal by the terminal device includes: not monitoring and receiving, by the network device and at the resource location of the to-be-measured inter-frequency reference signal and at N resource locations before and after the resource location of the to-be-measured inter-frequency reference signal, the uplink transmission from the terminal device.

Where the network device not sending data to the terminal device during the measurement on the to-be-measured inter-frequency reference signal by the terminal device includes: not sending, by the network device and at the resource location of the to-be-measured inter-frequency reference signal and at N resource locations before and after the resource location of the to-be-measured inter-frequency reference signal, the data to the terminal device.

In some examples, in an embodiment of the present disclosure, the apparatus is further configured to: determine the measurement scheduling requirement based on a protocol agreement.

In some examples, in an embodiment of the present disclosure, the network device not monitoring and receiving an uplink transmission from the terminal device includes at least one of: not monitoring or receiving a physical uplink control channel (PUCCH); not monitoring or receiving a physical shared control channel (PUSCH); or not monitoring or receiving a sounding reference signal (SRS).

In some examples, in an embodiment of the present disclosure, the network device not sending data to the terminal device includes at least one of: not sending a PDCCH to the terminal device; not sending a PDSCH to the terminal device; or not sending a TRS to the terminal device; or not sending a CSI for CQI to the terminal device.

In an embodiment of the present disclosure, the to-be-measured inter-frequency reference signal includes at least one of: an SSB; a CSI-RS; or a PRS.

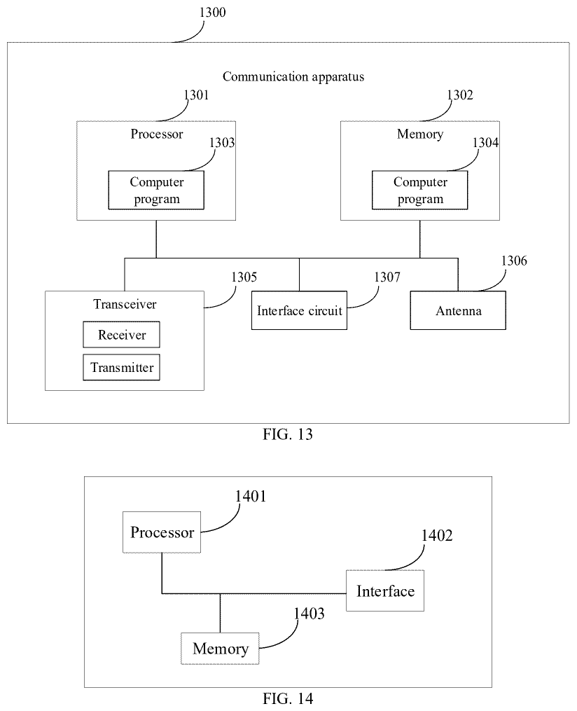

Referring to FIG. 13, FIG. 13 is a schematic structural diagram of a communication apparatus 1300 according to an embodiment of the present disclosure. The communication apparatus 1300 may be a network device, a terminal device, a chip, a chip system, or a processor that supports network device to implement the above method, or a chip, a chip system, or a processor that supports the terminal device to implement the methods. The apparatus can be configured to realize the methods described in the above-mentioned method embodiments, for details, please refer to the description in the above-mentioned method embodiments.

The communication apparatus 1300 may include one or more processors 1301. The processor 1301 may be a general-purpose processor or a specialized processor, etc. Such as a baseband processor or a central processing unit. The baseband processor can be configured to process communication protocols as well as communication data, and the central processor can be configured to control a communication apparatus (e.g., a base station, a baseband chip, a terminal device, a terminal device chip, a DU or a CU, etc.), execute a computer program, and process data from a computer program.

In some examples, the communication apparatus 1300 may further include one or more memories 1302, on which a computer program 1304 may be stored, and the processor 1301 executes the computer program 1304, so that the communication apparatus 1300 can execute the methods described in the above method embodiments. In some examples, data can also be stored in the memory 1302. The communication apparatus 1300 and the memory 1302 may be set separately or integrated together.

In some examples, the communication apparatus 1300 may further include a transceiver 1305 and an antenna 1306. The transceiver 1305 can be named as a transceiver unit, a transceiver machine, a transceiver circuit, etc., and is configured to realize transceiver functions. The transceiver 1305 may include a receiver and a transmitter, and the receiver may be named as a receiving machine or a receiving circuit, etc., and is configured to realize receiving functions. The transmitter can be named as a transmitting machine or a transmitting circuit, etc., and is configured to realize transmitting functions.

In some examples, the communication apparatus 1300 may further include one or more interface circuits 1307. The interface circuit 1307 is configured to receive code instructions and transmit them to the processor 1301. The processor 1301 executes the code instructions to cause the communication apparatus 1300 to perform the methods described in the above method embodiments.

In an implementation, the processor 1301 may include a transceiver for implementing receiving and transmitting functions. For example, the transceiver can be a transceiver circuit, an interface, or an interface circuit. The transceiver circuits, interfaces or interface circuits for receiving and transmitting functions can be separated or integrated. The transceiver circuit, interface or interface circuit can be configured to read and write codes/data, or the transceiver circuit, interface or interface circuit can be configured to signal transmission or delivery.

In an implementation, the processor 1301 can store a computer program 1303, and the computer program 1303 runs on the processor 1301, which can make the communication apparatus 1300 execute the methods described in the above-mentioned method embodiments. The computer program 1303 may be solidified in the processor 1301, in which case, the processor 1301 may be implemented by hardware.

In an implementation, the communication apparatus 1300 may include a circuit, which may realize the function of transmitting or receiving or communicating in the above-mentioned method embodiments. The processor and transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver can also be manufactured by various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the embodiments may be a network device or a terminal device, but the scope of the communication apparatus described in the present disclosure is not limited thereto, and the structure of the communication apparatus may not be limited by FIG. 13. The communication apparatus may be a stand-alone device or may be part of a larger device. For example, the communication apparatus may be: (1) a stand-alone integrated circuit IC, or chip, or system or subsystem of chips; (2) a collection of ICs having one or more, in some examples, the collection of ICs may also include storage components for storing data, computer programs; (3) an ASIC, such as a modem; (4) a module that can be embedded in other devices; (5) a receiver, a terminal device, an intelligent terminal device, a cellular phone, a wireless device, handset, mobile unit, a vehicle-mounted device, a network device, a cloud device, an artificial intelligence device, etc.; or (6) others, etc.

For the case that the communication apparatus can be a chip or a chip system, please refer to a structural schematic diagram of the chip shown in FIG. 14. The chip shown in FIG. 14 includes a processor 1401 and an interface 1402. The number of processors 1401 may be one or more and the number of interfaces 1402 may be more than one.

In some examples, and as shown in FIG. 14, the chip further includes a memory 1403 for storing necessary computer programs and data.

Those skilled in the art can also understand that various illustrative logical blocks and steps listed in the embodiments of the present disclosure can be implemented by electronic hardware, computer software, or a combination of both. Whether such a function is realized in hardware or software depends on specific application and design requirements of an overall system. Those skilled in the art can use various methods to realize the described functions for each specific application, but this realization should not be understood as beyond the scope of protection of the embodiments of the present disclosure.

The present disclosure further provides a non-transitory computer-readable storage medium on which instructions are stored, which, when executed by a computer, realize the functions of any of the method embodiments.

The present disclosure further provides a computer program product which, when executed by a computer, realizes the functions of any of the method embodiments.

In the embodiments, it can be realized in whole or in part by software, hardware, firmware or any combination thereof. When implemented using software, it may be implemented in whole or in part in the form of a computer program product. The computer program product includes one or more computer programs. When the computer program is loaded and executed on a computer, the flow or function according to the embodiments of the present disclosure is generated in whole or in part. The computer can be a general-purpose computer, a special-purpose computer, a computer network, or other programmable devices. The computer program can be stored in a non-transitory computer-readable storage medium or transmitted from one non-transitory computer-readable storage medium to another. For example, the computer program can be transmitted from a website, computer, server or data center to another website by wired (e.g., coaxial cable, optical fiber, digital subscriber line (DSL)) or wireless (e.g., infrared, wireless, microwave, etc.). The non-transitory computer-readable storage medium may be any available medium that can be accessed by a computer or a data storage device such as a server, data center, etc. that contains one or more available media integrated. The available medium may be a magnetic medium (e.g., floppy disk, hard disk, magnetic tape), an optical medium (e.g., high-density digital video disc (DVD)), or a semiconductor medium (e.g., solid state disk (SSD)), etc.

A person of ordinary skill in the art may understand that “first”, “second”, and other various numerical numbers involved in the present disclosure are only described for the convenience of differentiation, and are not used to limit the scope of the embodiments of the present disclosure, nor do they indicate the order of precedence.

“At least one” in the present disclosure can further be described as one or more, and “a plurality” can be two, three, four or more, and the present disclosure is not limited. In the embodiment of the present disclosure, for a technical feature, the technical feature is distinguished by “first”, “second”, “third”, “A”, “B”, “C” and “D” etc. The technical features described in “first”, “second”, “third”, “A”, “B”, “C” and “D” are in no order of priority or size.

The correspondence shown in each table in the present disclosure can be configured or predefined. The values of the information in each table are only examples, and can be configured as other values, and the present disclosure is not limited. When configuring a correspondence between the information and each parameter, it is not necessary to configure all correspondences illustrated in each table. For example, in the table in the present disclosure, corresponding relationships shown by some rows may not be configured. For another example, appropriate deformation adjustments can be made based on the above table, such as splitting, merging, etc. The names of the parameters shown in the titles of the above tables may also be other names understandable by the communication apparatus, and the values or expressions of the parameters may also be other values or expressions understandable by the communication apparatus. Each of the above tables may also be implemented with other data structures, for example, an array, queue, container, stack, linear table, pointer, chain table, tree, graph, structure, class, heap, hash table, or hash table may be used.

Predefined in the present disclosure may be understood as defined, pre-definition, stored, pre-stored, pre-negotiated, pre-configured, cured, or pre-fired.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled people can use different methods to implement the described functions for each specific application, but such implementation should not be considered beyond the scope of the present disclosure.

It is clearly understood by those skilled in the field to which it belongs that, for the convenience and brevity of the description, the specific working processes of the above-described systems, apparatuses, and units can be referred to the corresponding processes in the foregoing embodiments of the method, and will not be repeated herein.

The foregoing are only specific embodiments of the present disclosure, but the scope of protection of the present disclosure is not limited thereto, and any person skilled in the art who is familiar with the technical field of the present disclosure can readily think of changes or substitutions within the technical scope of the present disclosure, which should be covered within the scope of protection of the present disclosure. Therefore, the scope of protection of the present disclosure based on the scope of protection of the claims.

1. A measurement configuration method, performed by a terminal device and comprising:
determining, in response to that an inter-frequency measurement is to be performed on a to-be-measured inter-frequency reference signal, whether the to-be-measured inter-frequency reference signal is to be measured based on a measurement gap.

2. The method according to claim 1, further comprising:
reporting capability information to a network device, and
wherein the capability information indicates, when a resource location of the to-be-measured inter-frequency reference signal is comprised within a downlink active bandwidth part (BWP) of a current serving cell of the terminal device, whether the terminal device supports an inter-frequency measurement without the measurement gap.

3. The method according to claim 2, wherein determining whether the to-be-measured inter-frequency reference signal is to be measured based on the measurement gap comprises:
receiving indication signaling sent by the network device, wherein the indication signaling indicates whether a measurement gap is necessary for the terminal device to perform the inter-frequency measurement on the to-be-measured inter-frequency reference signal; and
measuring the inter-frequency reference signal based on the indication signaling.

4. The method according to claim 3, wherein measuring the inter-frequency reference signal based on the indication signaling comprises:
determining, in response to the indication signaling indicating that a measurement gap is not necessary for the terminal device to perform the inter-frequency measurement on the to-be-measured inter-frequency reference signal, a measurement scheduling requirement which comprises at least one of:
in a case that the terminal device is in a time division duplexing (TDD) bandwidth, the terminal device not performing an uplink transmission during a measurement on the to-be-measured inter-frequency reference signal,
in a case that a sub-carrier spacing (SCS) of the to-be-measured inter-frequency reference signal is different from a SCS of at least one of data or signal in the current serving cell, the terminal device not performing an uplink transmission or a downlink reception during the measurement on the to-be-measured inter-frequency reference signal, or
in a case that the terminal device is in a frequency range 2 (FR2) system, the terminal device not performing an uplink transmission or a downlink reception during the measurement on the to-be-measured inter-frequency reference signal; and
measuring the to-be-measured inter-frequency reference signal based on the measurement scheduling requirement.

5. The method according to claim 4,
wherein the terminal device not performing an uplink transmission during the measurement on the to-be-measured inter-frequency reference signal comprises:
measuring, by the terminal device and at the resource location of the to-be-measured inter-frequency reference signal and at N resource locations before and after the resource location of the to-be-measured inter-frequency reference signal, the inter-frequency reference signal but not performing the uplink transmission; and
wherein the terminal device not performing a downlink reception during the measurement on the to-be-measured inter-frequency reference signal comprises:
measuring, by the terminal device and at the resource location of the to-be-measured inter-frequency reference signal and at N resource locations before and after the resource location of the to-be-measured inter-frequency reference signal, the inter-frequency reference signal but not performing the downlink reception.

6. The method according to claim 4, wherein determining the measurement scheduling requirement comprises:
determining the measurement scheduling requirement based on a protocol agreement.

7. The method according to claim 4,
wherein the uplink transmission comprises at least one of:
sending a physical uplink control channel (PUCCH),
sending a physical uplink shared channel (PUSCH), or
sending a sounding reference signal (SRS); and
wherein the downlink reception comprises at least one of:
receiving a physical downlink control channel (PDCCH),
receiving a physical downlink shared channel (PDSCH),
receiving a tracking reference signal (TRS), or
receiving a channel state information-reference signal (CSI-RS) for channel quality indicator (CQI).

8. (canceled)

9. The method according to claim 3, wherein measuring the inter-frequency reference signal based on the indication signaling comprises:
performing, in response to the indication signaling indicating that the measurement gap is necessary for the terminal device to perform the inter-frequency measurement on the to-be-measured inter-frequency reference signal, the inter-frequency measurement on the to-be-measured inter-frequency reference signal based on the measurement gap.

10. The method according to claim 2, wherein determining whether the to-be-measured inter-frequency reference signal is to be measured based on the measurement gap comprises:
performing, in a case that the terminal device does not report the capability information to the network device, the inter-frequency measurement on the to-be-measured inter-frequency reference signal based on the measurement gap.

11. The method according to claim 1, wherein the to-be-measured inter-frequency reference signal comprises at least one of:
a synchronization signal block (SSB);
a channel state information-reference signal (CSI-RS); or
a positioning reference signal (PRS).

12. A measurement configuration method, performed by a network device, comprises:
receiving capability information reported by a terminal device, and
wherein the capability information indicates, when a resource location of a to-be-measured inter-frequency reference signal is comprised within a downlink active bandwidth part (BWP) of a current serving cell of the terminal device, whether the terminal device supports an inter-frequency measurement without a measurement gap.

13. The method according to claim 12, further comprising:
sending indication signaling to the terminal device, wherein the indication signaling indicates whether a measurement gap is necessary for the terminal device to perform the inter-frequency measurement on the to-be-measured inter-frequency reference signal.

14. The method according information to claim 13, wherein sending the indication signaling to the terminal device based on the capability information comprises:
sending, in response to the capability information indicating that the terminal device supports the inter-frequency measurement without the measurement gap when the resource location of the to-be-measured inter-frequency reference signal is comprised within the downlink active BWP of the current serving cell of the terminal device, the indication signaling to the terminal device for indicating that a measurement gap is not necessary for the terminal device to perform the inter-frequency measurement on the to-be-measured inter-frequency reference signal.

15. The method according information to claim 13, wherein sending the indication signaling to the terminal device based on the capability information comprises:
sending, in response to the capability information indicating that the terminal device supports the inter-frequency measurement without the measurement gap when the resource location of the to-be-measured inter-frequency reference signal is comprised within the downlink active BWP of the current serving cell of the terminal device, the indication signaling to the terminal device for indicating that a measurement gap is necessary for the terminal device to perform the inter-frequency measurement on the to-be-measured inter-frequency reference signal; or
sending, in response to the capability information indicating that the terminal device does not support the inter-frequency measurement without the measurement gap when the resource location of the to-be-measured inter-frequency reference signal is comprised within the downlink active BWP of the current serving cell of the terminal device, the indication signaling to the terminal device for indicating that a measurement gap is necessary for the terminal device to perform the inter-frequency measurement on the to-be-measured inter-frequency reference signal.

16. (canceled)

17. The method according to claim 14, further comprising:
determining a measurement scheduling requirement, wherein the measurement scheduling requirement comprises at least one of:
in a case that the terminal device is in a time division duplexing (TDD) bandwidth, the network device not monitoring and receiving an uplink transmission from the terminal device during a measurement on the to-be-measured inter-frequency reference signal by the terminal device,
in a case that a sub-carrier spacing (SCS) of the to-be-measured inter-frequency reference signal is different from a SCS of at least one of data or signal in the current serving cell, the network device not monitoring and receiving an uplink transmission from the terminal device or not sending data to the terminal device during the measurement on the to-be-measured inter-frequency reference signal by the terminal device, or
in a case that the terminal device is in a frequency range 2 (FR2) system, the network device not monitoring and receiving an uplink transmission from the terminal device or not sending data to the terminal device during the measurement on the to-be-measured inter-frequency reference signal by the terminal device; and
performing a scheduling based on the measurement scheduling requirement.

18. The method according to claim 17,
wherein the network device not monitoring and receiving an uplink transmission from the terminal device during the measurement on the to-be-measured inter-frequency reference signal by the terminal device comprises:
not monitoring and receiving, by the network device and at the resource location of the to-be-measured inter-frequency reference signal and at N resource locations before and after the resource location of the to-be-measured inter-frequency reference signal, the uplink transmission from the terminal device; and
wherein the network device not sending data to the terminal device during the measurement on the to-be-measured inter-frequency reference signal by the terminal device comprises:
not sending, by the network device and at the resource location of the to-be-measured inter-frequency reference signal and at N resource locations before and after the resource location of the to-be-measured inter-frequency reference signal, the data to the terminal device.

19. The method according to claim 17, wherein the determining a measurement scheduling requirement comprises:
determining the measurement scheduling requirement based on a protocol agreement.

20. The method according to claim 17,
wherein the network device not monitoring and receiving an uplink transmission from the terminal device comprises at least one of:
not monitoring or receiving a physical uplink control channel (PUCCH),
not monitoring or receiving a physical shared control channel (PUSCH), or
not monitoring or receiving a sounding reference signal (SRS); and
wherein the network device not sending data to the terminal device comprises at least one of:
not sending a physical downlink control channel (PDCCH) to the terminal device;
not sending a physical downlink shared channel (PDSCH) to the terminal device;
not sending a tracking reference signal (TRS) to the terminal device, or
not sending a channel state information-reference signal (CSI-RS) for channel quality indicator (CQI) to the terminal device.

21. (canceled)

22. The method according to claim 12, wherein the to-be-measured inter-frequency reference signal comprises at least one of:
a synchronization signal block (SSB);
a channel state information-reference signal (CSI-RS); or
a positioning reference signal (PRS).

23-24. (canceled)

25. A communication apparatus, comprising: a processor and a memory, wherein a computer program is stored in the memory, and the processor executes the computer program stored in the memory, so that the apparatus is configured to determine, in response to that an inter-frequency measurement is to be performed on a to-be-measured inter-frequency reference signal, whether the to-be-measured inter-frequency reference signal is to be measured based on a measurement gap.

26-27. (canceled)
